(19) United States
(12) Patent Application Publication
(10) Pub. No.: US 2012/0150751 A1
(43) Pub. Date: Jun. 14, 2012

(54) Dialog Page Interaction Model

(75) Inventors: Prabhat Kumar Pandey, Hyderabad (IN); Gonzalo Ruiz, Seattle, WA (US)

(73) Assignee: Microsoft Corporation, Redmond, WA (US)

(21) Appl. No.: 12/967,877

(22) Filed: Dec. 14, 2010

(51) Int. Cl. G06Q 10/00

(52) U.S. Cl. 705/301

(57) ABSTRACT

Techniques for a dialog page interaction model are described to implement dialog management for a customer relationship management (CRM) system. A workflow defining a set of actions to complete for a business process record can trigger a dialog that includes pages having a set of interactive activities. In a metadata generation mode, the CRM system can construct the page using state information that is stored as client data in one or more databases. The CRM system can also create a bookmark for the workflow in connection with the page that can be employed to resume the workflow. In a response delivery mode, the CRM system can resume the workflow to the bookmark position. To do so, the CRM system can employ the bookmark and stored state data to set the workflow to conditions and values defined by the bookmark.

### BACKGROUND

Through a customer relationship management (CRM) system, clients may be provided with resources to manage a variety of customer centric business processes, such as sales opportunities, product marketing, service calls, project management, and so forth. One technique for management of business processes involves dialogs that may guide a user through a set of tasks assigned to the user in the context of a particular case or record for a business process. For example, a dialog can be employed to guide a service operator through a service call from a customer. Traditionally, though, dialogs are designed statically and are run in a stateless way with limited interaction between the dialogs and the CRM system. This approach, although effective for relatively simple dialogs, can make it difficult to implement more creative dialogs that support dynamic content and can be used to handle complex business process scenarios.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Techniques for a dialog page interaction model are described that can be employed to implement dialog management in a cooperative manner between a CRM system and a client. In at least some embodiments, a workflow defining a set of actions to complete for a business process record can trigger a dialog that includes one or more pages having a set of interactive activities. In a metadata generation mode, the CRM system can construct a page for the dialog from the workflow using state information that is stored as client data in one or more databases. The CRM system can also create a bookmark in the workflow that can be employed to resume the workflow. The bookmark can be configured as a resume point that defines conditions and values for the position of the bookmark in the workflow. In a response delivery mode, the CRM system can resume the workflow to the bookmark position. To do so, the CRM system can employ stored state data regarding the workflow and/or page results to set the workflow to conditions and values defined by the bookmark.

### BRIEF DESCRIPTION OF THE DRAWINGS

The same numbers are used throughout the drawings to reference like features.

FIG. 1 illustrates an operating environment in which various principles described herein can be employed in accordance with one or more embodiments.

FIG. 2 illustrates an example user interface for a dialog page in accordance with one or more embodiments.

FIG. 3 illustrates an example scenario involving a dialog page interaction model in accordance with one or more embodiments.

FIG. 4 is a flow diagram that describes steps of a method in accordance with one or more embodiments.

FIG. 5 is flow diagram that describes steps of another method in accordance with one or more embodiments.

FIG. 6 is flow diagram that describes steps of another method in accordance with one or more embodiments.

FIG. 7 illustrates an example computing system that can be used to implement one or more embodiments.

### DETAILED DESCRIPTION

Overview

Techniques for a dialog page interaction model are described that can be employed to implement dialog management in a cooperative manner between a CRM system and a client. In at least some embodiments, a workflow defining a set of actions to complete for a business process record can trigger a dialog that includes one or more pages having a set of interactive activities.

In a metadata generation mode, the CRM system can construct a page for the dialog from the workflow using state information that is stored as client data in one or more databases. The CRM system can create a bookmark in the workflow that can be employed to resume the workflow when a page response for the page is received from a client. The bookmark can be configured as a resume point associated with the workflow that defines conditions and values for the position of the bookmark in the workflow. In a response delivery mode, the CRM system can resume the workflow to a position of a bookmark. To do so, the CRM system can employ stored state data regarding the workflow and/or pages to set the workflow to conditions and values defined by the bookmark.

In the discussion that follows, a section titled “Operating Environment” is provided and describes one environment in which one or more embodiments can be employed. Following this, a section titled “Dialog Page Interaction Model Examples” describes an example scenario in accordance with one or more embodiments. Next, a section titled “Example Methods” describes example techniques for a dialog page interaction model in accordance with one or more embodiments. Last, a section titled “Example System” describes example computing systems and devices that can be utilized to implement one or more embodiments.

Operating Environment

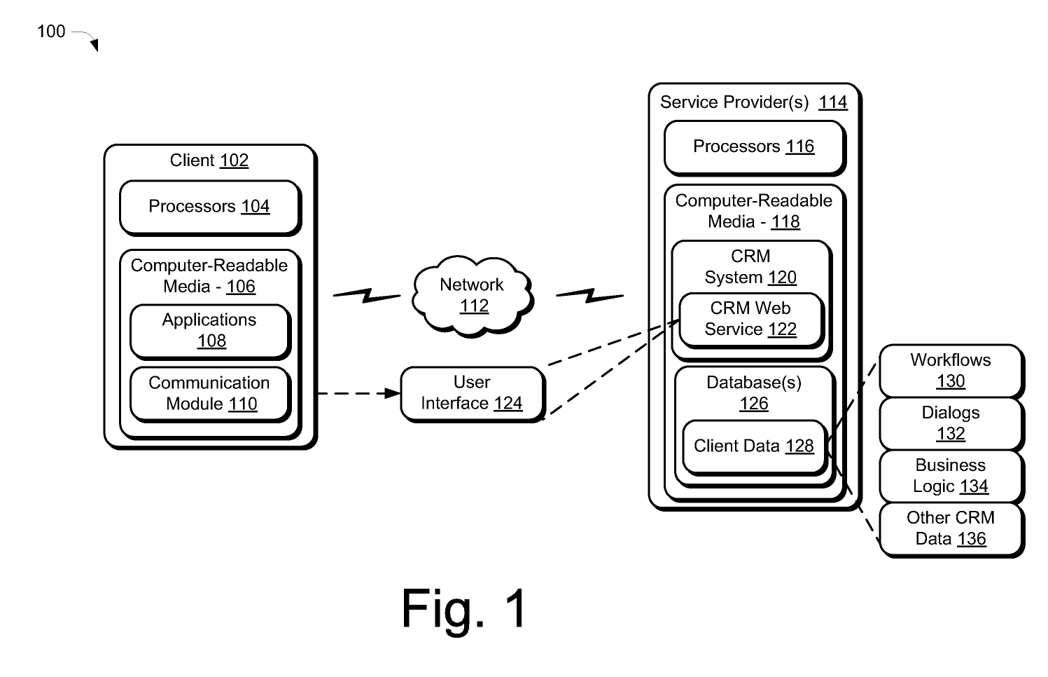

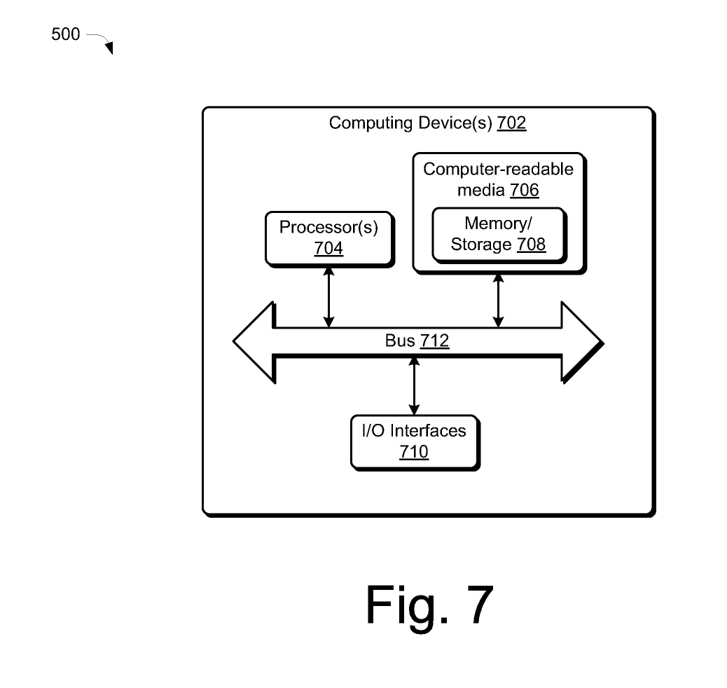

FIG. 1 illustrates an operating environment in accordance with one or more embodiments, generally at 100. Environment 100 includes a client 102 having one or more processors 104, one or more computer-readable media 106 and one or more applications 108 that reside on the computer-readable media and which are executable by the processor(s). The client 102 can be embodied as any suitable computing system and/or device such as, by way of example and not limitation, a desktop computer, a portable computer, a handheld computer such as a personal digital assistant (PDA), a cell phone, a set-top box, and the like. One example of a computing system that can represent various systems and/or devices including the client 102 is shown and described below in FIG. 7.

The computer-readable media can include, by way of example and not limitation, all forms of volatile and non-volatile memory and/or storage media that are typically associated with a computing device. Such media can include ROM, RAM, flash memory, hard disk, removable media and the like. Computer-readable media can include both “computer-readable storage media” and “communication media,” examples of which can be found in the discussion of the example computing system of FIG. 7.

In addition, client 102 includes a software application in the form of a communication module 110. The communication module 110 represents functionality of the client 102 operable to communicate with and interact with various other entities (e.g., other clients, providers, servers, web sites). For example, the communication module 110 may be configured as a web browser. Interactions with other entities can include sending and receiving electronic messages in various forms (e.g., e-mail, instant messages, application specific notifications, text messages, and so forth) between the entities, obtaining resources (e.g., content and services) from the other entities, and so forth.

For instance, the client 102 can be communicatively coupled over a network 112, such as the Internet, with one or more service providers 114 from and to which content can be received and sent. The service providers 114 are each depicted as having one or more processors 116 and one or more computer-readable media 118. A service provider 114 can be implemented by way of one or more server devices. Accordingly, various example components represented and described for a service provider 114 can be included on a single server device and/or can be divided between multiple different server devices.

The service provider 114 is depicted as including a customer relationship management (CRM) system 120. The CRM system 120 represents functionality operable by a service provider 114 to provide various CRM related resources to the client 102 over the network 112. For example, the CRM system 120 can include or otherwise make use of CRM web service 122 to provide various resources to assist clients in management of business processes, including but not limited to sales opportunities, product marketing, service calls, and so forth. The CRM web service 122 can include or make use of a navigation manager configured to facilitate navigation of clients 102 to access various user interfaces that enable interaction with the various resources. The CRM system 120 provides a set of standard resources that clients 102 may take advantage to manage the business processes as well as custom and customizable resources that clients can adapt to fit particular operating procedures, processes, product characteristics, personnel structures, and other custom practices.

In at least some embodiments, the CRM system 120 makes resources available by way of web pages, HTML pages, application UIs, or other user interfaces 124 that are communicated over the network 112 via the CRM web service 122 for output by the client 102. The CRM system 120 can manage access to the resources, performance of the resources, configuration of user interfaces 124 or data to provide the resources, and so on. The client 102 can access the user interfaces 124 via a communication module 110, such as a browser. One or more applications 108 can also be configured to access user interfaces 124 and/or other CRM related resources. For example, a personal information management (PIM) client application or other desktop application 108 can make use of a CRM add-in that interacts with the CRM system 120 to obtain CRM related resources. In a particular example, a PIM client application can be employed to facilitate scheduling of actions, tasks, calls, and/or other events associated with particular CRM cases/projects that are assigned to particular users for completion. One example of a PIM client application is Microsoft Outlook®.

In addition, the CRM system 120 can include or otherwise make use of one or more databases 126 configured to store a variety of different client data 128 related to business processes of clients 102 that are managed through the CRM system 120. As depicted in FIG. 1, client data 128 can include workflows 130, dialogs 132, and business logic 134.

Workflows 130 represent automated and/or asynchronous flows that can be run to completion without relying upon user inputs. The workflows 130 define a set of actions to complete for a particular business process case or project. A workflow 130 therefore represents a structure or template that can be triggered to automatically manage actions for a corresponding business process. For example, a workflow 130 may relate to processing a potential sales opportunity. The workflow in this example can perform management actions such as assigning tasks regarding the potential sales opportunity to users (e.g., employees or other personnel), tracking progress of the tasks, creating and routing documents, sending communications to appropriate personnel, facilitating approval processes, triggering subsequent actions based on preceding actions, and so forth. In general, the workflow 130 operates in connection with a particular case or record for a business process to control the flow of actions from initiation to completion of the instance. This can include triggering and assigning actions including dialogs 132 to personnel as appropriate along the way. Workflows 130 are therefore configured to automate back-end processing for corresponding business processes.

Dialogs 132 represent interactive or synchronous processes that involve user inputs to run to completion. The dialogs 132 can relate to various interaction activities defined by a business process and controlled by a workflow. A dialog can include or be loaded with data for a corresponding business process record (e.g., contextual data) as well as having interactive questions, answers, selections, and so forth that are designed to guide a user in completing one or more tasks in connection with the business process record. A dialog can be associated with one or more pages each of which can include a number of interactive prompt and response components. The dialog 132 and/or pages therefore facilitate completion of front-end interaction activities that are driven by user inputs for a corresponding business process. For instance, a dialog can be implemented as a wizard-like interface that steps a user through a set of actions and pages to complete an assigned task, such as a sales follow-up call in the above example of a potential sales opportunity.

In at least some embodiments, dialogs 132 can be configured as particular kinds of workflows in accordance with a dialog page interaction model described above and below. The dialog can include definitions for variables and arguments to store local and/or temporary data. These variables and arguments can be used with a particular dialog and/or can be used to pass data externally, such as to another dialog or workflow. More particularly, dialogs can be arranged together in a chain or a multiple level hierarchy. In this arrangement, a “parent” dialog can be configured to prompt another “child” dialog, which can further link to another “child” dialog, link back to the parent itself (e.g., loop back), prompt a further dialog, and so forth. Accordingly, variables and arguments defined in connection with a particular dialog can be mapped and passed to a child dialog. This approach establishes a modular and reusable dialog definition that enables dialogs to be created quickly and easily maintained.

In general, the dialog page interaction model is designed to facilitate page and prompt/response generation as well as bookmarking and resuming of workflows for interaction activities. The dialog page interaction model can be configured to implement both a metadata generation mode that can be used to construct pages and a response delivery mode that enables resumption of a workflow to a bookmarked position. Details regarding these and other aspects of the dialog page interaction model are discussed in relation to the following figures.

Business logic 134 represents business specific logic that can be used to drive workflows 130 and/or define custom activities, dialogs 132, tasks, and so forth. Different business logic 134 is typically associated with each particular business entity that uses the CRM system 120. Thus, business logic 134 can represent data that defines the structure, steps, flow, and/or personnel involved in business processes for a business entity. A variety of other CRM data 136 is also contemplated examples of which include case records, contact lists, task management tools, operational data, product documentation, support data, pricing data, customer account information, and so forth.

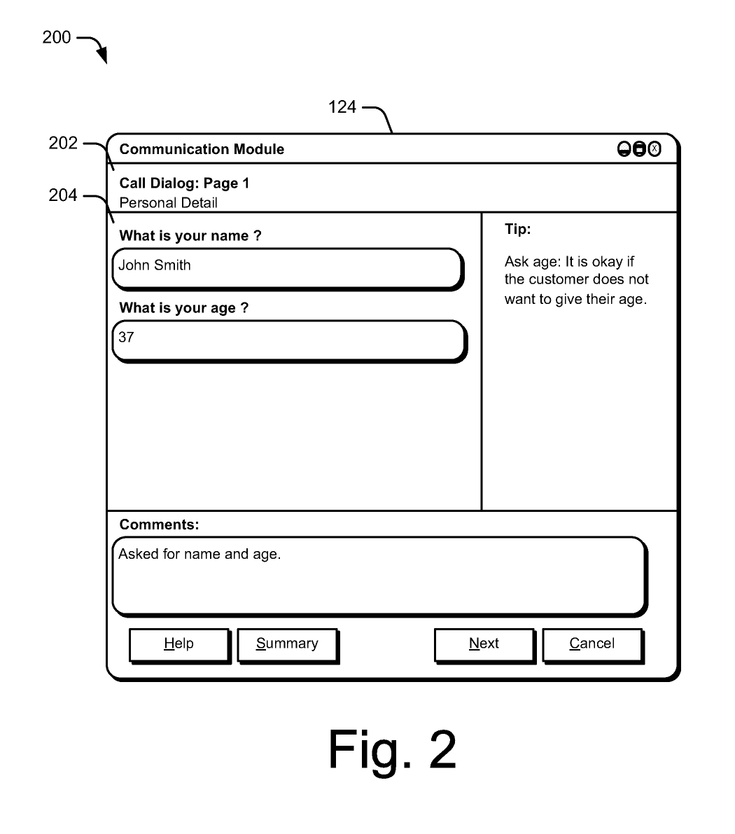

For illustrative purposes, FIG. 2 depicts generally at 200 one example of a user interface 124 for a dialog 132 that can be output by the CRM system 120 to assist in completion of an interaction activity in connection with a workflow 130. In this example, the user interface 124 includes a page 202 for the dialog that can include one or more prompt and response components 204. The page 202 acts as a container for the prompt and response components 204 associated with the dialog 132. The prompt and response components 204 represent interactive components for the dialog that are used to guide a user through an activity, collect responses, and return results to the CRM system 120. The page 202 and the prompt and response components 204 can be dynamically generated by a corresponding workflow 130 for an interaction activity defined in the workflow 130 as described above and below. To complete the dialog 132, a user can follow the guidance provided by the form, provide input for the prompt and response components 204, and select the “Next” button or other suitable control to move to another page and/or submit a page response. Additional details regarding dialog completion can be found in relation to the following figures.

Having described an example operating environment, consider now a discussion of some dialog page interaction model examples in accordance with one or more embodiments.

Dialog Page Interaction Model Examples

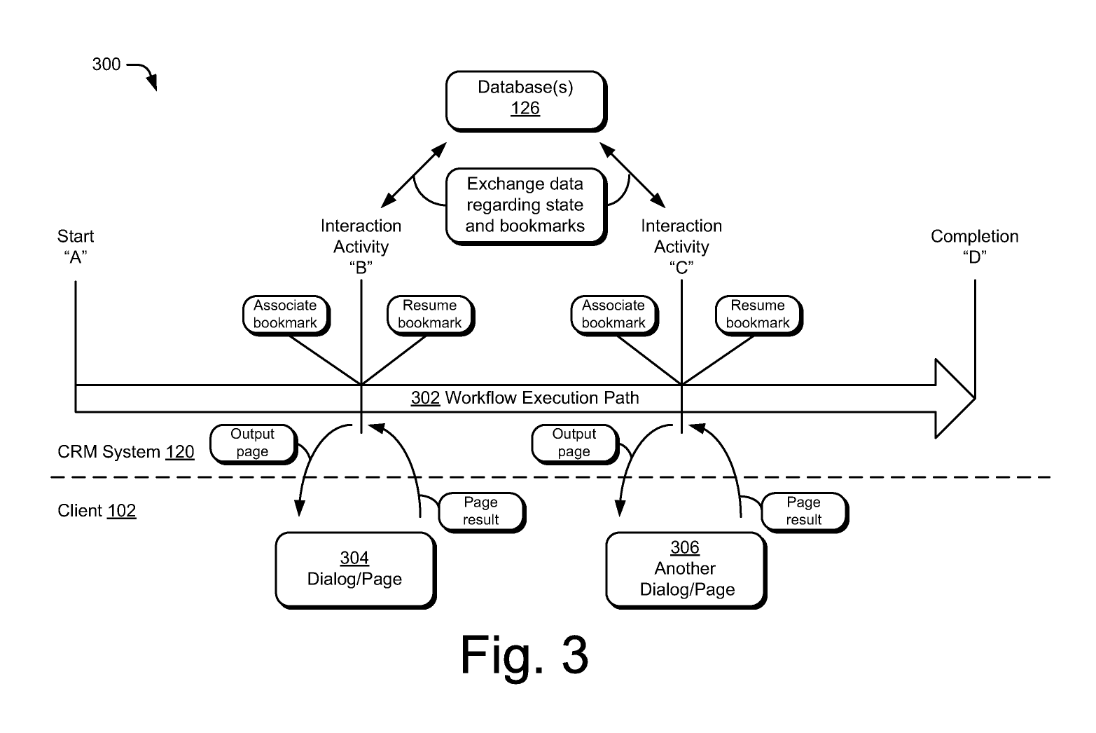

In one or more embodiments, a dialog page interaction model can be implemented by a CRM system 120 to facilitate interaction between pages that clients 102 interact with and the CRM system 120. In accordance with the model, the client 102 and CRM servers that host workflows 130 can operate in a stateless way while enabling the CRM system 120 to store state data for bookmarking and resuming workflows 130. Moreover, the CRM system 120 can store page state data in connection with a business record that can permit a client to “roll-back” a particular dialog 132 to an earlier position if appropriate. In this context, consider the following discussion to further illustrate some example aspects of a dialog page interaction model in accordance with one or more embodiments. These aspects are discussed in relation to an example scenario that is depicted in FIG. 3.

In particular, FIG. 3 depicts generally at 300 an example in which a workflow 130 for a business process can trigger various interaction activities in accordance with a dialog page interaction model. The depiction includes a representation of a workflow execution path 302. Although the example workflow execution path 302 is illustrated as a linear path for the sake of simplicity, it should be appreciated that a workflow can be configured to include different branches, decision points, breaks, and so forth. Workflows can also be configured to jump between one another so that in practice execution paths can become quite complex.

In the illustrated example, however, the workflow execution path 302 progresses from a start point “A” to a completion point “D.” In the course of a workflow 130, there can be multiple points at which interaction activities are encountered, examples of which are shown in FIG. 3 as interaction activity point “B” and interaction activity point “C.” When interaction activities are encountered in a workflow 130, this can cause dialogs 132 and/or corresponding pages to be output by the CRM system 120 for a client 102. Here, a dialog/page 304 and another dialog/page 306 are represented as being output in connection with the interaction activity point “B” and interaction activity point “C,” respectively.

In operation, workflows 130 can be hosted by servers in a stateless manner. More particularly, the CRM web service 122 can be implemented via multiple load balanced servers that work together to execute workflows on an as needed basis. In the course of its execution, a workflow 130 can be loaded and unloaded a number of times, such as being unloaded to handle an interaction activity and being loaded again after the interaction activity. Overall, the execution of a workflow 130 can occur via one server or across multiple servers. In other words, a workflow can be paused and unloaded on one server and then resumed and reloaded via the same server or a different server. Therefore, the server infrastructure for the CRM web service 122 is not necessarily designed to keep track of workflow states for various workflows 130 that are running.

Accordingly, the dialog page interaction model provides a mechanism by which state information regarding a workflow 130 can be saved and resumed. Moreover, in accordance with the dialog page interaction model, a dialog workflow can be defined as a particular kind of workflow 130. In this case, the dialog workflow can be defined to include multiple pages 202 (e.g., interaction activities) having one or more prompt and response components 204 per page.

Workflows 130 including dialog workflows can be defined using an XML based language such as XAML or other suitable programming language including but not limited to C#, C++, HTML, and JavaScript, to name a few examples. Workflows 130 can be related one to another such that a particular workflow can cause other sub-workflows to be executed. Thus, a dialog workflow can be prompted by another workflow designed to handle a particular business process case or project as a whole.

In this context, assume now that the example workflow execution path 302 corresponds to a dialog workflow. During runtime, when the dialog workflow is executed in a given context, corresponding pages can be output when interaction activities are encountered in the dialog workflow as shown in FIG. 3. The dialog workflow can be configured to implement back-end processing and decision logic for a dialog that determines when to provide pages, determines what pages to provide, and configures appropriate pages. For example, the dialog workflow can perform intermediate decision logic between transitions from one page to another to ascertain a next page to be presented. The intermediate decision logic can be based at least in part upon results obtained through one or more previous pages.

At interaction activity points, such as the example interaction activity point “B” and interaction activity point “C” in FIG. 3, bookmarks can be associated with the workflow execution path 302 to bookmark the workflow, and then pages can be output by the CRM system 120 for the client 102. Bookmarks can be configured in any suitable way to designate a bookmark location within an associated workflow. For example, bookmarks can be configured as XML tags, links, strings, or designators that are embedded in a workflow definition document to point to a corresponding bookmark location within a workflow. The bookmarks can also be configured as external designators and/or documents that link to or otherwise point to corresponding bookmark locations within a workflow. Further, bookmarks can be configured as resume points that include or are otherwise associated with data describing conditions and values of a workflow at corresponding positions in the workflow execution path 302.

A data exchange can occur between the CRM web service 122 and databases 126 to offload data regarding the bookmark location (e.g., bookmark designators) and state data that is sufficient to enable the dialog workflow to be reloaded at a later time. The offloaded data can be stored as part of a business process record associated with the dialog workflow. Then, the dialog workflow can be paused and/or unloaded pending completion of the interaction activity.

At the client 102, the page is presented, processed to obtain specified information, and when the page is completed a page response can be returned to the CRM system 120. The page response can carry results of the page and context information regarding the dialog workflow. The context information is sufficient to enable the CRM web service 122 to identify/retrieve the business process record corresponding to the dialog/page, store the results of the page, and/or resume the appropriate dialog workflow at the bookmark.

In particular, the CRM web service 122 can use the context information in a data exchange with the databases 126 to identify the bookmark location and load state data to resume the dialog workflow at the bookmark. The workflow execution path 302 is un-paused and processing continues until the next interaction activity is encountered or the workflow reaches completion. Further details regarding these and other aspects of a dialog page interaction model can be found in relation to the following figures.

Having considered the example scenario above, consider now example procedures for a dialog page interaction model in accordance with one or more embodiments.

Example Methods

The following section provides a discussion of flow diagrams that describe steps of example methods for a dialog page interaction model in accordance with one or more embodiments. The methods can be implemented in connection with any suitable hardware, software, firmware, or combination thereof. In at least some embodiments, the methods can be implemented by way of a suitability configured computing device, such as the example service provider 114 of FIG. 1 that includes or otherwise makes use of CRM system 120 and/or CRM web service 122.

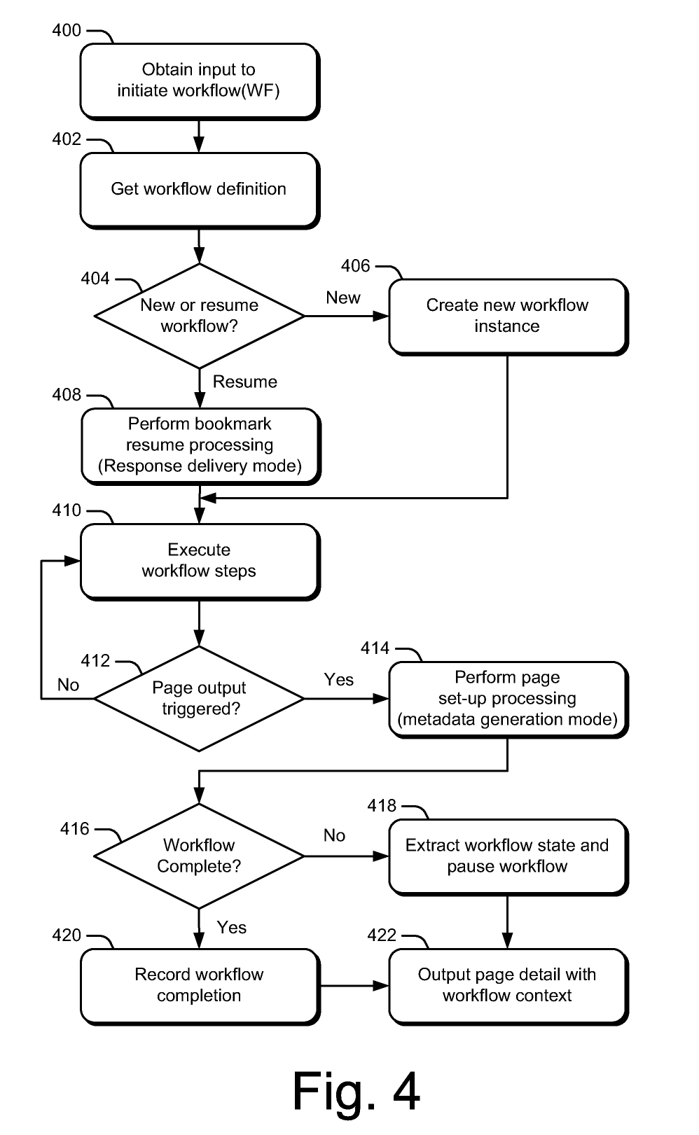

FIG. 4 is a flow diagram that describes steps of a method in accordance with one or more embodiments. In particular, FIG. 4 depicts a method having details of transitions for interaction activities and pages that are controlled in accordance with a dialog page interaction model.

Step 400 obtains input to initiate a workflow (WF) and step 402 gets a workflow definition for the workflow. A workflow can be initiated in various ways. For example, a workflow corresponding to a business process can be initiated for each case or project that is managed through the CRM system 120 when a record for the business process is created. A workflow also can be initiated in response to a page request from a client 102 and/or from another workflow 130. The CRM system 120 can further be configured to automatically initiate workflows upon the occurrence of designated events or triggers. For example, a call handling workflow can be initiated automatically by the CRM system 120 in response to monitoring of calls placed to a customer service center.

When a workflow is initiated, a workflow definition for the workflow can be obtained from a suitable storage location, such as from the databases 126. In at least some embodiments, the CRM web service 122 can be configured to maintain and retrieve workflow definitions from a workflow definition cache. The workflow definition cache can maintain workflow definitions for fast retrieval and to avoid repetitive instantiation of workflows. This can result in a significant reduction in memory usage and processing cycles.

Step 404 determines whether to create a new workflow or resume an existing workflow. The determination regarding whether the workflow is new or existing can occur in any suitable way. In at least some embodiments, this involves determining whether a bookmark is included in or otherwise associated with the workflow. For example, the CRM web service 122 can examine and parse the workflow definition to identify an XML tag or other suitable bookmark associated with the workflow definition. Identifiers for a workflow and or bookmark can also be included with context information that is provided in a page response received from clients 102. Such identifiers can also include data to directly indicate whether a requested workflow is new or existing, such as a Boolean field.

When a new workflow is determined, step 406 creates a new workflow instance. The new workflow instance can be created in connection with a corresponding business process record, such as a particular customer service call, appointment, or project. The workflow instance can be loaded and run with context information that is associated with the corresponding business process record.

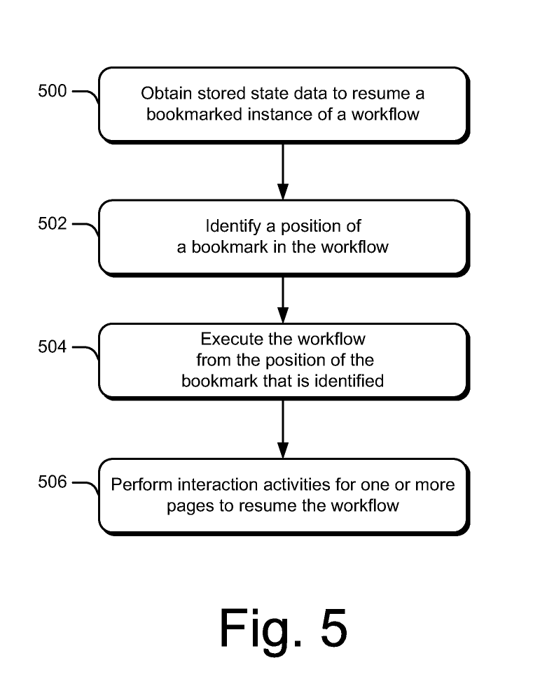

When an existing workflow to resume is determined, step 408 performs bookmark resume processing to resume the workflow. For instance, an existing workflow can be loaded to a bookmark position that is stored as client data 128 via the databases 126. The bookmark resume processing to resume a workflow can include processing specified by a response delivery mode, details of which can be found in relation to the example method of FIG. 5.

Steps 410 executes the workflow steps defined by the workflow. This occurs using the state data that is loaded through the new workflow or the resumed workflow. The workflow operates to perform various back-end processing according to business logic to control the flow of both back-end and front-end actions. To do so, the workflow 130 can be configured to perform back-end actions, trigger and/or assign front-end interaction activities (e.g., dialogs and pages) to appropriate personnel, monitor the front-end interaction activities, obtain results of the back-end actions and front-end interaction activities, and make decisions on processing steps to take next to manage the flow based on results obtained from preceding steps. Thus, interaction activities can be encountered at various points along the execution path that trigger output of pages to facilitate the interaction.

Step 412 determines whether a page output is triggered. For example, events or triggers in a workflow that cause various interaction activities can occur. These events or triggers can be detected through monitoring. Additionally or alternatively, various interaction activity points in the workflow that trigger corresponding pages can simply be arrived at in the course of executing the workflow. As long as a page is not triggered, the workflow can continue to execute per step 410. The workflow can continue to execute until a page is triggered and/or until the workflow is processed through to completion.

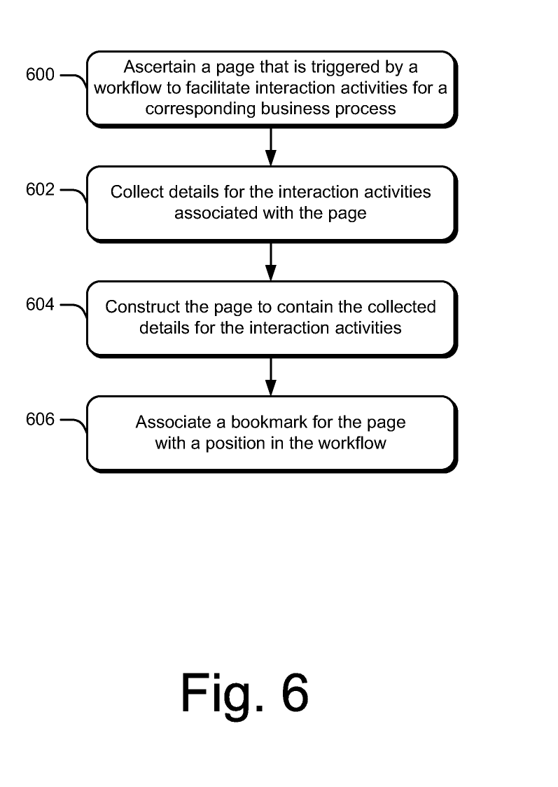

If a page is triggered, though, step 414 performs page set-up processing. For instance, page data stored as client data 128 via the databases 126 and/or state data for a page can be loaded and used to construct an appropriate page having various prompt and response components as described above and below. The page set-up processing to create pages can include processing specified by a metadata generation mode, details of which can be found in relation to the example method of FIG. 6.

Once a page has been constructed per step 414, step 416 determines whether the workflow is complete. If the workflow is not complete, step 418 extracts the workflow state and pauses the workflow. A bookmark to resume the paused workflow can also be associated with the workflow at this point. Additionally or alternatively, a bookmark can be associated with a workflow in connection with processing specified by a metadata generation mode in step 414. Now, the workflow can be unloaded pending a page response as described above. On the other hand, if the work flow is complete, step 420 records the workflow completion and the workflow can be unloaded.

In either case, step 422 outputs the page detail with workflow context. For instance, the page can be communicated by the CRM web service 122 over the network 112 for receipt by the client 102. The page can be sent along with context information to enable the client 102 to process the page and generate a page response. The page response can trigger the process just described to be repeated for the next page with the workflow handling the intermediate processing between page transitions. Thus, a workflow can be loaded, unloaded, and reloaded at various times in connection with interaction activities encountered in the execution path.

FIG. 5 is a flow diagram that describes steps of another method in accordance with one or more embodiments. In particular, FIG. 5 depicts a method having details regarding a response delivery mode. The response delivery mode can be implemented to simulate page processing that has occurred for a workflow instance to return the workflow to a bookmarked position. In other words, the CRM system 120 in response delivery mode is configured to run through the execution path of a workflow using stored state data and bookmarks to bring the workflow to a bookmarked position.

Step 500 obtains stored state data to resume a bookmarked instance of the workflow. State data for a workflow can include variable values, arguments, bookmarks, context data, settings, page results obtained in page responses, and/or other data associated with the workflow that can be stored for example as client data 128 for a record. The state data can be obtained through exchanges with databases 126 to obtain selected client data. If a workflow instance is not already active, the workflow definition can also be obtained and used to activate the workflow instance.

Step 502 identifies a position of a bookmark in the workflow. For example, the state data obtained in step 500 can be examined to ascertain a bookmark position for the workflow. This can involve parsing the state data to find an XML tag or other suitable designator that indicates the bookmarked position.

It should be noted that multiple bookmark positions can be associated with a workflow. These bookmark positions can act as resume points that can be selected to roll-back a workflow to a selected point. Generally, bookmarks can be inserted for each interaction activity (e.g., each page) in a workflow. In one example, a client 102 can interact with the CRM web service 122 to obtain a list of bookmark positions maintained in connection with a workflow. The listed bookmark positions may be selectable to cause the CRM web service 122 to roll-back the workflow to a selected position. An identifier of a selected position can be included with state data collected in step 500 or otherwise be passed in to cause processing in the response delivery mode to resume the selected position.

Once the bookmarked position is identified, step 504 executes the workflow from the resumed position. In particular, the workflow resumes operation at the position of the bookmark and can perform various back-end processing according to business logic to control the flow of both back-end and front-end actions.

Further, step 506 performs interaction activities for one or more pages to resume the workflow at the position of the bookmark that is identified. In this step, the CRM system 120 performs processing to resume the workflow to the position designated by the bookmark. This can involve setting variable values, arguments, context data, settings, and/or other data in accordance with the state data collected for the workflow. Data can be passed between workflows and dialogs as appropriate. In particular, the workflow is set to state that existed when the bookmark was created.

To do so, the CRM system 120 can simulate the interaction activities that occurred in the workflow up to the bookmark position. Here, the CRM system 120 can use page results to run through one or more pages in a manner that reproduces the information input into the pages to set the workflow to the bookmarked position. This interaction activity simulation can occur transparently without actually outputting the pages again to the client 102.

At various points in the workflow execution there can be interaction activities that trigger output of dialogs/pages as previously mentioned. When this happens, processing in a metadata generation mode can occur to create appropriate pages and associate bookmarks with the pages and/or interaction activities. Details regarding the metadata generation mode are described in relation to the following figure.

FIG. 6 is a flow diagram that describes steps of another method in accordance with one or more embodiments. In particular, FIG. 6 depicts a method having details regarding a metadata generation mode. The metadata generation mode can be implemented to create pages for interaction activities defined by a workflow. In other words, the CRM system 120 in metadata generation mode is configured to build pages for dialogs having prompt and response components to facilitate interaction activities defined by a workflow, such as the example page 202 of FIG. 2. Metadata generation mode can also include processing to associate bookmarks with a workflow in connection with pages and/or interaction activities.

Step 600 ascertains a page that is triggered by a workflow. For instance, the page can be triggered in various ways described herein to facilitate interaction activities for a corresponding business process. For example, a page can be prompted from a workflow or another page based upon business logic that is encoded in a workflow designed to handle processing for a particular business process. As but one example, a page such as the example page 202 of FIG. 2 can be initiated to collect personal detail information for a customer in connection with a customer service call.

Step 602 collects details for the interaction activities associated with the page. For example, the CRM web service 122 can be configured to use state data and/or results from previous interaction to make decisions regarding pages to present to a client 102 as noted previously. In this way, pages can be dynamically selected and/or configured based upon decision making logic implemented by a workflow. The CRM web service 122 can be further configured to collect data to build a page in accordance with the decision making logic. This can involve selecting and/or configuring one or more pages for a dialog to include particular interactive components that are designed to guide a user through completion of a corresponding interaction activity in the workflow that triggered the dialog/page output.

Various data can be collected including state data, previous page results, page definitions, prompt and response definitions, and other data used to create pages. At least some of this data can be stored in the one or more databases 126 as client data 128 or in another suitable storage location. Data that is collected can also include pre-configured pages, code templates for pages, and/or prompt and response components that can be made available in a page library accessible to the CRM web service 122.

Step 604 constructs the page to contain the collected details for the interaction activities. In particular, the CRM web service 122 can use the various data collected in step 602 to construct a page that includes prompt and response components selected to implement the interaction for which the page is designed. The page can be a pre-configured page associated with a particular activity. A page or portions thereof can also be dynamically generated based upon state data and/or previous page results. This can occur by using code templates to dynamically configure at least some portions of the page. Pages, templates, code, bookmarks, and so forth can be defined and implemented using any suitable techniques including but not limited to XML based code, documents, and tags. Other forms of code as mentioned above can also be used to implement pages and/or components of the pages.

Accordingly, a page can be constructed to selectively include various prompt and response components that are interactive components for a page used to guide a user through an activity, collect responses, and return results to the CRM system 120. The page can be constructed to act as a container for the various prompt and response components. To complete the dialog/page, a user can follow the guidance provided by the page and provide input for the prompt and response components. The user can then select a “Next” button or other suitable control to move to another page and/or submit a page response.

In addition to constructing a page as just described, step 606 associates a bookmark for the page with a position in the workflow. This can include inserting a bookmark into the workflow or otherwise associating a bookmark with a corresponding position in a workflow. The bookmark can be configured in various ways as discussed above, such as using embedded XML tags or links, external references, and/or other suitable designators. Any suitable bookmark that is configured to designate a position within a workflow can be employed. Bookmarks are designed to enable the CRM system 120 to resume a workflow at a particular bookmarked position. For instance, bookmarks can be used in the response delivery mode as previously described to resume a workflow to an identified position.

Having considered various example methods for a dialog page interaction model, consider now an example system that can be employed to implement various aspects of a dialog page interaction model in accordance with one or more embodiments.

Example System

FIG. 7 illustrates an example system generally at 700 that includes an example computing device 702 that is representative of one or more such computing systems and/or devices that may implement the various embodiments described above. The computing device 702 may be, for example, a server of a service provider 114, a device associated with the client 102 (e.g., a client device), an on-chip system, and/or any other suitable computing device or computing system.

The example computing device 702 includes one or more processors 704 or processing units, one or more computer-readable media 706 which may include one or more memory and/or storage components 708, one or more input/output (I/O) interfaces 710 for input/output (I/O) devices, and a bus 712 that allows the various components and devices to communicate one to another. Computer-readable media 706 and/or one or more I/O devices may be included as part of, or alternatively may be coupled to, the computing device 702. The bus 712 represents one or more of several types of bus structures, including a memory bus or memory controller, a peripheral bus, an accelerated graphics port, and a processor or local bus using any of a variety of bus architectures. The bus 712 may include wired and/or wireless buses.

The one or more processors 704 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions. The memory/storage component 708 represents memory/storage capacity associated with one or more computer-readable media. The memory/storage component 708 may include volatile media (such as random access memory (RAM)) and/or nonvolatile media (such as read only memory (ROM), Flash memory, optical disks, magnetic disks, and so forth). The memory/storage component 708 may include fixed media (e.g., RAM, ROM, a fixed hard drive, etc.) as well as removable media (e.g., a Flash memory drive, a removable hard drive, an optical disk, and so forth).

Input/output interface(s) 710 allow a user to enter commands and information to computing device 702, and also allow information to be presented to the user and/or other components or devices using various input/output devices. Examples of input devices include a keyboard, a cursor control device (e.g., a mouse), a microphone, a scanner, and so forth. Examples of output devices include a display device (e.g., a monitor or projector), speakers, a printer, a network card, and so forth.

Various techniques may be described herein in the general context of software, hardware (fixed logic circuitry), or program modules. Generally, such modules include routines, programs, objects, elements, components, data structures, and so forth that perform particular tasks or implement particular abstract data types. An implementation of these modules and techniques may be stored on or transmitted across some form of computer-readable media. The computer-readable media may include a variety of available medium or media that may be accessed by a computing device. By way of example, and not limitation, computer-readable media may include “computer-readable storage media” and “communication media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. Computer-readable storage media also includes hardware elements having instructions, modules, and/or fixed device logic implemented in a hardware form that may be employed in some embodiments to implement aspects of the described techniques.

The computer-readable storage media includes volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, hardware elements (e.g., fixed logic) of an integrated circuit or chip, or other storage device, tangible media, or article of manufacture suitable to store the desired information and which may be accessed by a computer.

“Communication media” may refer to a signal bearing medium that is configured to transmit instructions to the hardware of the computing device, such as via the network 112. Communication media typically may embody computer readable instructions, data structures, program modules, or other data in a modulated data signal, such as carrier waves, data signals, or other transport mechanism. Communication media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

Combinations of any of the above are also included within the scope of computer-readable media. Accordingly, software, hardware, or program modules, including the CRM web service 122 and other components of a CRM system 120, applications 108, communication module 110, and other program modules, may be implemented as one or more instructions and/or logic embodied on some form of computer-readable media.

Accordingly, particular modules, functionality, components, and techniques described herein may be implemented in software, hardware, firmware and/or combinations thereof. The computing device 702 may be configured to implement particular instructions and/or functions corresponding to the software and/or hardware modules implemented on computer-readable media. The instructions and/or functions may be executable/operable by one or more articles of manufacture (for example, one or more computing devices 702 and/or processors 704) to implement techniques for a dialog page interaction model, as well as other techniques. Such techniques include, but are not limited to, the example procedures described herein. Thus, computer-readable media may be configured to store or otherwise provide instructions that, when executed by one or more devices described herein, cause various techniques for a dialog page interaction model.

### CONCLUSION

Techniques for a dialog page interaction model have been described herein. As described, a workflow defining a set of actions to complete for a business process record can trigger a dialog that includes one or more pages having a set of interactive activities. In a metadata generation mode, the CRM system can generate the page using state information that is stored as client data in one or more databases. The CRM system can also create a bookmark for the workflow in connection with the page that can be employed to resume the workflow. In a response delivery mode, the CRM system can resume the workflow to the bookmark position. To do so, the CRM system can employ the bookmark and stored state data regarding the workflow and/or pages to set the workflow to conditions and values defined by the bookmark.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. One or more computer-readable storage media storing instructions, that when executed by a computing device, cause the computing device to implement an customer relationship management (CRM) system configured to perform acts comprising:
executing a workflow in connection with a record for a business process in the CRM system;
initiating a dialog associated with the workflow, the dialog configured to facilitate completion of an interaction activity defined for the business process that is driven by user inputs;
selectively constructing one or more pages for the dialog to collect the user inputs for the interaction activity;
associating a bookmark with the workflow to designate a position in the workflow to which the workflow can be resumed;
unloading the workflow pending completion of the one or more pages; and
responsive to receiving a page response indicative of completion of the one or more pages, reloading the workflow using the bookmark to resume execution of the workflow at the position designated by the bookmark.

2. The one or more computer-readable storage media of claim 1, wherein the customer relationship management (CRM) system is further configured to implement:
a response delivery mode to perform bookmark resume processing to reload workflows using associated bookmarks; and
a metadata generation mode to perform page set-up processing to selectively configure pages for interaction activities encountered in the workflows when executed via the CRM system.

3. The one or more computer-readable storage media of claim 1, wherein the workflow is configured to automate a set of actions defined by the workflow for the business process.

4. The one or more computer-readable storage media of claim 1, wherein the workflow is configured as a dialog workflow to implement the dialog using different pages to complete multiple interaction activities.

5. The one or more computer-readable storage media of claim 1, wherein reloading the workflow using the bookmark comprises:
collecting state data describing results from previous interaction with the workflow;
identifying a position of the bookmark associated with the workflow;
simulating interaction activities for one or more pages defined by the workflow to resume the workflow to the position of the bookmark that is identified; and
executing the workflow from the resumed position.

6. The one or more computer-readable storage media of claim 1, wherein executing the workflow comprises obtaining a workflow definition from a workflow cache.

7. The one or more computer-readable storage media of claim 1, further comprising:
outputting the one or more pages that are constructed to a client for completion; and
pausing the workflow pending completion of the one or more pages by the client.

8. The one or more computer-readable storage media of claim 1, further comprising extracting state data regarding the state of the workflow at the position designated by the bookmark and storing the state data in association with the bookmark to enable the workflow to be resumed at the position designated by the bookmark.

9. The one or more computer-readable storage media of claim 1, wherein selectively constructing the one or more pages comprises:
ascertaining the one or more pages being triggered by the interaction activity defined in the workflow;
collecting details for the interaction activity to determine prompt and response components to include in the one or more pages;
configuring the one or more pages to include the determined prompt and response components to facilitate the interaction activity.

10. The one or more computer-readable storage media of claim 1, wherein the bookmark is configured as a resume point that defines conditions and values for the position of the bookmark in the workflow.

11. A computer implemented method comprising;
obtaining stored state data to resume a bookmarked instance of a workflow for a customer relationship management (CRM) system;
identifying a position of a bookmark in the workflow;
simulating interaction activities for one or more pages defined by the workflow to resume the workflow to the position of the bookmark that is identified; and
executing the workflow from the resumed position.

12. The computer implemented method of claim 11, further comprising:
receiving a page response including a selection of the position of the bookmark from among multiple bookmarks to cause the CRM system to roll-back the workflow to the selected position; and
performing the obtaining, identifying, and simulating in response to the selection to roll-back the workflow to the selected position.

13. The computer implemented method of claim 11, wherein the state data includes one or more of variable values, arguments, context data, settings, or page results obtained in page responses that are stored in association with the bookmark.

14. The computer implemented method of claim 11, wherein identifying the position of a bookmark in the workflow comprises parsing the state data to find a designator indicative of the position of the bookmark.

15. The computer implemented method of claim 11, wherein the workflow is configured to automate a set of actions defined by the workflow for a corresponding business process.

16. A computer implemented method comprising;
ascertaining a page that is triggered by a workflow to facilitate interaction activities for a corresponding business process in a CRM system;
collecting details for the interaction activities associated with the page;
constructing the page to contain the collected details for the interaction activities; and
associating a bookmark for the page with a position in the workflow.

17. The computer implemented method of claim 16, wherein the workflow is configured to perform intermediate decision logic between transitions from one page to another to construct pages based at least in part upon results obtained through one or more previous pages.

18. The computer implemented method of claim 16, wherein the page corresponds to dialog configured to facilitate completion of the interaction activities for the corresponding business process that are driven by user inputs.

19. The computer implemented method of claim 16, further comprising:
outputting the page that is constructed to a client for completion; and
unloading the workflow pending completion of the page by the client.

20. The computer implemented method of claim 19, further comprising reloading the workflow using the bookmark to resume execution of the workflow at the position of the bookmark responsive to receiving a page response indicative of completion of the page.
